(19) United States
(12) Patent Application Publication
(10) Pub. No.: US 2006/0190933 A1
(43) Pub. Date: Aug. 24, 2006

(54) METHOD AND APPARATUS FOR QUICKLY DEVELOPING AN EMBEDDED OPERATING SYSTEM THROUGH UTILIZING AN AUTOMATED BUILDING FRAMEWORK

(76) Inventor: Ruey-Yuan Tzeng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/160,976

(22) Filed: Jul. 18, 2005

(30) Foreign Application Priority Data
Feb. 22, 2005 (TW) 094105248

(51) Int. Cl. G06F 9/45

(52) U.S. Cl. 717/140

(57) ABSTRACT

A method and apparatus for developing an embedded operating system. The method includes: providing a utility source code, a pre-built configuration framework and an automated building framework; and utilizing the automated building framework for automatically compiling the utility source code to generate a plurality of utility binary programs and for automatically integrating the pre-built configuration framework and the utility binary programs into a root file system of the embedded operating system.

### BACKGROUND OF THE INVENTION

1. Field of the Invention

The present invention provides a method and an apparatus for developing an operating system, and more particularly, to a method and an apparatus for quickly developing an embedded operating system.

2. Description of the Prior Art

Embedded systems and their related application devices are increasingly popular. Many devices, both in production and in development, utilize embedded systems. These devices include: information appliances (IA), smart phones, and set-top boxes among many others. Embedded systems are typically composed of computer software (e.g., an embedded operating system) and computer hardware (e.g., system single chip). The embedded system is developed based on a specific purpose. Because of this narrow development goal, the embedded system, as compared with a typical personal computer, has advantages including: high stability, small volume, and low cost. For the embedded system, many products such as Palm OS, Windows CE, or Linux are utilized. The Linux operating system is especially popular because it is available as freeware.

Please refer to FIG. 1. FIG. 1 is a flowchart of developing an embedded operating system in the related art. The flowchart includes the following steps:

Step 100: Prepare a plurality of component source codes needed by an embedded operating system.

Step 102: Configure a component source code, which is not compiled in a plurality of component source codes.

Step 104: Compile the configured component source code.

Step 106: Is the component source code compiled to a corresponding component successfully? If yes, proceed to step 110; otherwise proceed to step 108.

Step 108: Configure the component source code again, and then proceed to step 104.

Step 110: Are the plurality of component source codes already compiled successfully? If yes, proceed to step 112; otherwise proceed to step 102.

Step 112: Integrate the plurality of compiled components to generate a root file system.

Step 114: Remove the unnecessary components to decrease the required volume of memory.

Step 116: Compress the root file system to an image file; and

Step 118: Load the image file to a target device and test whether the root file system corresponding to the image file can be executed normally.

The above steps are described as follows. A designer of an embedded operating system (target device) is required to design a proper embedded operating system according to the need of the embedded operating system. Therefore, the designer stores component source codes of a plurality of components needed by the embedded operating system (e.g. source codes of kernel, library, and application program) to a developing system (e.g. a host PC). Then, the designer configures each component source code through an integrated IDE (integrated development environment) provided from a development system. Each component has its own function and operation. To successfully understand each component and the relation between components, the designer must have a breadth of knowledge and significant depth of specific domain knowledge of the software and hardware. The component source code cannot successfully perform compilation to generate the needed component when a component source code corresponding to a component is incorrectly configured. In other words, the component source code fails to be compiled. The designer must review the configuration of the component source code, modify the component source code, and recompile the component source code. This compiling and configuring process continues to repeat until the component source code is successfully compiled.

After the plurality of component source codes are successfully compiled, the designer generates an integrated root file system utilizing the developing system to integrate the plurality of compiled components. Since the target device is typically limited in storage volume, the unnecessary components will be removed in the root file system in an effort to decrease the usage volume of the memory. For example, since the developing tools (e.g. a compiler) do not execute in the target device, the developing tools will be removed to lower the actual volume.

Finally, to successfully test the above-mentioned root file system on the target device, the root file system will be compressed to an image file. The image file will be downloaded to the target device to test the operation of the root file system. In the event that the root file system operates abnormally, the designer must dedicate significant time to the process of debugging. After debugging, the designer must again proceed with the developing processes manually. Typically, an experienced designer requires about one week developing a prototype system.

From the above description, the prior art embedded operating system developing method suffers from these defects:

(1) A designer needs to fully understand the components; otherwise it becomes easy to misconfigure the component source codes. Incorrect configuration of component source codes will result in a failed compilation.

(2) The prior art embedded operating system developing processes are very complicated and dependent on each other.

(3) When the designer needs to verify and test the prototype system, the designer must utilize special software and hardware to download the developed root file system to the target device. This process is complicated and requires a significant amount of time.

### SUMMARY OF THE INVENTION

One objective of the claimed invention is therefore to provide a method and an apparatus for quickly developing an embedded operating system utilizing an automated building framework, to solve the above-mentioned problems.

According to an exemplary embodiment of the present invention, a method for developing an embedded operating system is disclosed. The method comprises: providing a utility source code, a pre-built configuration framework, and an automated building framework; and executing the automated building framework to automatically compile the utility source code to generate a plurality of utility binary programs, and automatically integrate the pre-built configuration framework and the plurality of utility binary programs to generate a root file system of the embedded operating system.

According to another exemplary embodiment of the present invention, an apparatus for developing an embedded operating system is disclosed. The apparatus comprises: a storage device comprising an utility source code, a pre-built configuration framework and an automated building framework; and a microprocessor coupled to the storage device for executing the automated building framework to automatically compile the utility source code to generate a plurality of utility binary programs, and automatically integrating the pre-built configuration framework and the plurality of utility binary programs to generate a root file system of the embedded operating system.

The present invention apparatus for quickly developing an embedded operating system and method enjoys these advantages:

(1) The designer does not require any software or hardware knowledge of the embedded operating system. The designer may generate a system prototype of an embedded operating system through an automated building framework.

(2) Realization of time savings during verification and debugging of the developing process because software components of the pre-built configuration framework are verified first.

(3) Since the automated building framework is automatically, it can save significant development time.

(4) The developing result is a Meta image, which can let the designer have flexibility to choose test mechanism to test the developing root file system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of developing an embedded operating system in the related art.

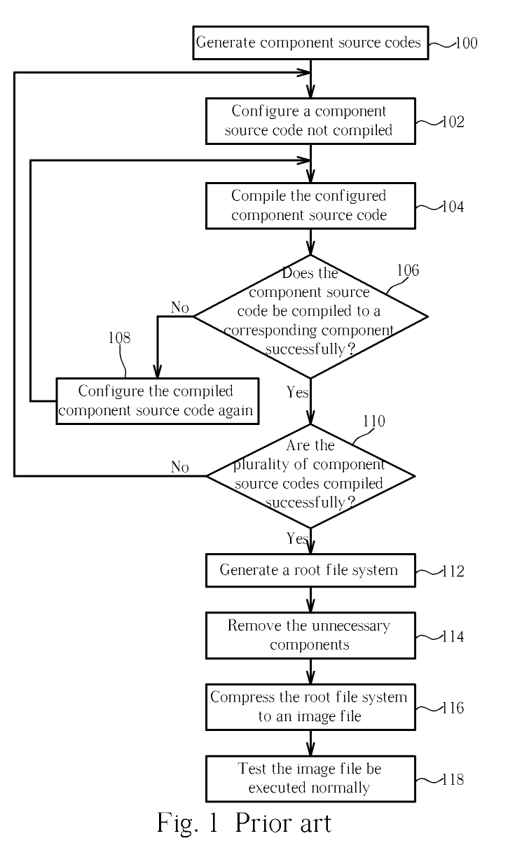

FIG. 2 is a flowchart of developing an embedded operating system of the present invention.

FIG. 3 is a block diagram of an embedded operating system apparatus according to an embodiment of the present invention.

### DETAILED DESCRIPTION

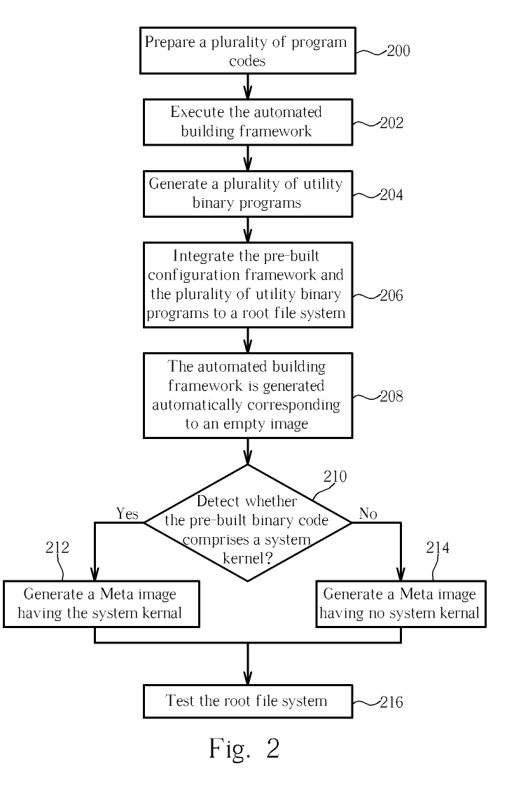

Please refer to FIG. 2. FIG. 2 is a flowchart for developing an embedded operating system of the present invention. The operation of developing the embedded operating system of the present invention is described as follows:

Step 200: Prepare a utility source code, a pre-built binary code, a pre-built configuration framework, and an automated building framework in a developing system.

Step 202: Execute the automated building framework.

Step 204: Utilize the automated building framework to automatically read the utility source code and to compile the utility source code to generate a plurality of utility binary programs.

Step 206: Utilize the automated building framework automatically to read the pre-built configuration framework and the plurality of utility binary programs, and to automatically integrate the pre-built configuration framework and the plurality of utility binary programs to a root file system.

Step 208: The automated building framework is generated automatically corresponding to an empty image of specific file system format.

Step 210: Automatically detect whether the pre-built binary code comprises a system kernel through the automated building framework. If yes, proceed to step 212; otherwise, proceed to step 214.

Step 212: Utilize the automated building framework automatically to integrate the pre-built binary code (except the system kernel) to the root file system, and automatically write the root file system and the system kernel to the empty image to generate a Meta image. Then proceed to step 216.

Step 214: Utilize the automated building framework automatically to integrate the pre-built binary code to the root file system, and automatically write the root file system into the empty image to generate a Meta image; and

Step 216: Test whether the root file system corresponding to the Meta image can be executed normally.

The detailed description of the above-mentioned developing processes is illustrated as follows. A designer executes the development process of the embedded operating system in a developing system (e.g. a host PC). Firstly, the designer loads a utility source code, a pre-built binary code, a pre-built configuration framework, and an automated building framework into the developing system. In the present embodiment, the pre-built configuration framework satisfies the file system framework of a Linux standards base (LSB), and can be considered to have a simplified root file system having a plurality of directories (e.g., /, /etc, /usr, /dev, and /bin). Additionally, a plurality of software elements of the pre-built configuration framework is previously verified to ensure correct operation. In other words, error probability of software components in the pre-built configuration framework is almost equal to zero when utilized in operating conditions. In the present embodiment, the pre-built configuration framework does not comprise any tool software, but parts of verified tool software can be optionally set in the pre-built configuration framework according to design needs. This capability is well within the range of the present invention. Please note that the present invention can also be quickly utilized to develop a prototype system of an embedded operating system. In addition, the root file system corresponding to the pre-built configuration framework does not require configuration for a specific purpose embedded operating system. Being very dynamic, the root file system corresponding to the pre-built configuration framework supports almost all types of functions needed by embedded operating systems. Although the prototype system generated from the embedded operating system of the present invention method has larger data information, the needed prototype system can be quickly developed of the embedded operating system according to the present invention. This development is a simple matter regardless of the type of the embedded operating system needed by the designer.

The utility source code comprises source codes corresponding to a plurality of tool software. For example, the plurality of tool software is a system shell program (e.g. bash shell), a file processing tool (e.g. cp, mv, and mkdir), and a software management program (e.g. rpm). In the present embodiment, the utility source codes are established according to specific software source codes such as BusyBox. Additionally, the pre-built binary code comprises a system kernel or a plurality of system libraries (e.g. glibc and libnss). A script is utilized for the automated building framework to control the developing process of operating embedded operating system. In other words, the automated building framework provides an automatic processing mechanism. The functionality and operation of the automated building framework are described as follows.

After the utility source code, the pre-built binary code, the pre-built configuration framework, and the automated building framework are loaded into the developing system (step 200), the designer executes the automated building framework to perform an automated processing mechanism (step 202). The automated building framework performs the operation of compiling and linking to the utility source code to generate a plurality of utility binary programs (e.g. system shell program, file processing tool and software management program in step 204). The automated building framework proceeds by reading the utility source code, utilizing the compiler, utilizing the linker, and utilizing either the cross compiler or cross linker supplied with the developing system. Then, the automated building framework integrates the pre-built configuration framework and the plurality of utility binary programs to a root file system (step 206). At this moment, a simplified pre-built configuration framework of root file system supports more functionality by adding the plurality of utility binary programs. Then the automated building framework generates an empty image, the whish file system format can satisfy specification of ISO 9660, JFFS2, EXT2, EXT3, ROMFS, CRAMFS, or RAMDISK. For example, the automated building framework executes a prior art instruction “dd” to establish a storage space, and then executes another prior art instruction “mkfs” to format the storage space to establish the empty image of a needed file system format.

The pre-built binary code can comprise a system kernel or a plurality of system libraries. If the pre-built binary code comprises the system kernel and the plurality of system libraries at the same time then step 210 can detect the pre-built binary code having system kernel. In the present embodiment, the automated building framework integrates the plurality of system libraries to the present root file system to further expand the functionality. Then the automated building framework writes the root file system and the system kernel into the empty image to generate a Meta image (step 212). This provides the Meta image with the ability of booting. If the pre-built binary code only comprises a plurality of system libraries, step 210 detects the pre-built binary code does not have a system kernel. Then the automated building framework integrates the plurality of system libraries to the present root file system to further expand its functionality. Then the automated building framework writes the root file system into the empty image to generate a Meta image having no system kernal (step 214). Since the Meta image only comprises the root file system but no system kernal, it does not have the ability of booting. Please note that if the pre-built binary code only comprises the system kernel, the present root file system of step 212 does not change, and the automated building framework only writes the root file system and the system kernel into the empty image to generate a Meta image.

Like the developing process of the prior art, the last step of the present invention developing process is to test whether the root file system corresponding to the Meta image executes normally (step 216). The present embodiment utilizes two testing mechanisms:

(1) Execute simulation software (e.g. VMWare) to test the Meta image. Since the simulation software and the developing system is executed in the same host PC, it can save time compared to the prior art developing process that requires the downloading of the Meta image to a target device (e.g. embedded operating system in network).

(2) Utilize a target device (e.g. embedded operating system in network) to test the Meta image.

Since the present invention developing method of the embedded operating system utilizes an automated building framework, the designer does not need to generate the Meta image manually. In other words, if the root file system cannot pass the verification in step 216, the automated building framework can quickly generate another Meta image to test after the designer finishes debugging, and therefore decreases the system developing time.

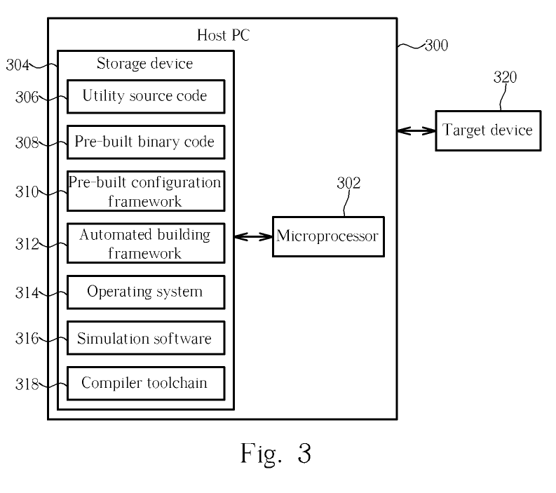

Please refer to FIG. 3. FIG. 3 is a block diagram of an embedded operating system apparatus according to an embodiment of the present invention. In this embodiment, the apparatus for developing an embedded operating system is a host PC 300 comprising a microprocessor 302 and a storage device 304 (e.g. hard disk). As shown in FIG. 3, the storage device 304 comprises a utility source code 306, a pre-built binary code 308, a pre-built configuration framework 310, an automated building framework 312, an operating system 314, simulation software 316, and a compiler toolchain 318. The functionality and operation of the utility source code 306, the pre-built binary code 308, the pre-built configuration framework 310, the automated building framework 312, and the simulation software 316 are described above. Further discussion is omitted for the sake of brevity. The compiler toolchain 318 comprises a compiler, a linker, and a cross compiler or a cross linker. A designer can utilize the host PC 300 to develop prototype system of an embedded operating system. The host PC 300 loads and executes operating system 314 (e.g. Linux operating system) so that it may function as a developing system (after a required rebooting). The designer inputs an instruction causing the host PC 300 to execute the automated building framework 312. The automated building framework 312 reads and utilizes the compiler toolchain 318 to generate a plurality of tool software according to the utility source code 306. In other words, the automated building framework 312 automatically generates a Meta image according to the steps 204˜214. The designer has the option to load the Meta image into the external target device 320 to verify, or execute the simulation software 316 to test the Meta image utilizing the host PC 300 itself.

Compared with the prior art, the present invention apparatus for quickly developing an embedded operating system and method have the following advantages:

(1) The designer is not required to possess software and hardware knowledge of the embedded operating system and can therefore successfully generate a prototype system of an embedded operating system through an automated building framework.

(2) Significant time is saved during the debugging process because the software components of the pre-built configuration framework are verified first.

(3) Significant development time is saved because the building framework is automated.

(4) The development result is a Meta image that allows the designer flexibility to choose various test mechanism to test the developing root file system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for developing an embedded operating system comprising:
(a) providing a utility source code, a pre-built configuration framework, and an automated building framework; and
(b) executing the automated building framework to automatically compile the utility source code to generate a plurality of utility binary programs, and automatically integrating the pre-built configuration framework and the plurality of utility binary programs to generate a root file system of the embedded operating system.

2. The method of claim 1, wherein step (a) further comprises: providing a pre-built binary code, which does not comprise a system kernel of the embedded operating system, and step (b) further comprises: automatically integrating the pre-built binary code into the root file system.

3. The method of claim 1, wherein step (b) further comprises: automatically generating an empty image and automatically writing the root file system into the empty image to generate a Meta image.

4. The method of claim 3, wherein step (a) further comprises: providing a pre-built binary code, which is a system kernel of the embedded operating system, and step (b) further comprises: automatically writing the system kernel into the Meta image.

5. The method of claim 3, wherein a file system format corresponding to the empty image satisfies a specification of: ISO 9660, JFFS2, EXT2, EXT3, ROMFS, CRAMFS, or RAMDISK.

6. The method of claim 3, wherein step (a) further comprises: providing simulation software and the method further comprises: executing the simulation software to load the Meta image to test an operation of the root file system.

7. The method of claim 1, wherein a plurality of software elements in the pre-built configuration framework are successfully verified.

8. The method of claim 1, wherein the pre-built configuration framework satisfies a file system framework of a Linux standards base (LSB).

9. The method of claim 1, wherein step (a) further comprises: providing a compiler toolchain and the automated building framework utilizes the compiler toolchain to automatically compile the utility source code to generate the plurality of utility binary programs.

10. An apparatus for developing an embedded operating system comprising:
a storage device comprising: a utility source code, a pre-built configuration framework, and an automated building framework; and
a microprocessor coupled to the storage device for executing the automated building framework to automatically compile the utility source code to generate a plurality of utility binary programs, and automatically integrating the pre-built configuration framework and the plurality of utility binary programs to generate a root file system of the embedded operating system.

11. The apparatus of claim 10, wherein the storage device further comprises a pre-built binary code, not including a system kernel of the embedded operating system, and the microprocessor further executes the automated building framework to automatically integrate the pre-built binary code to the root file system.

12. The apparatus of claim 10, wherein the microprocessor further executes the automated building framework to automatically generate an empty image, and automatically write the root file system into the empty image to generate a Meta image.

13. The apparatus of claim 12, wherein the storage device further comprises a pre-built binary code, which is a system kernel of the embedded operating system, and the microprocessor further executes the automated building framework to automatically write the system kernel into the Meta image.

14. The apparatus of claim 12, wherein a file system format corresponding to the empty image satisfies a specification of: ISO 9660, JFFS2, EXT2, EXT3, ROMFS, CRAMFS, or RAMDISK.

15. The apparatus of claim 12, wherein the storage device further comprises:
simulation software and the microprocessor further executes the simulation software to load the Meta image to test an operation of the root file system.

16. The apparatus of claim 10, wherein a plurality of software elements of the pre-built configuration framework are all successfully verified.

17. The apparatus of claim 10, wherein the pre-built configuration framework satisfies a file system framework of a Linux standards base (LSB).

18. The apparatus of claim 10, wherein the storage device further comprises: a compiler toolchain and the automated building framework utilizes the compiler toolchain to automatically compile the utility source code to generate the plurality of utility binary programs.
